(19) United States
(12) Patent Application Publication
(10) Pub. No.: US 2018/0285421 A1
(43) Pub. Date: Oct. 4, 2018

(54) DATABASE MANAGEMENT SYSTEM AND DATABASE MANAGEMENT METHOD

(71) Applicants: Hitachi, Ltd., Tokyo (JP); The University of Tokyo, Tokyo (JP)

(72) Inventors: Takayuki Tsuchida, Tokyo (JP); Norifumi Nishikawa, Tokyo (JP); Kazuhiko Mogi, Tokyo (JP); Kazuo Goda, Tokyo (JP); Yuto Hayamizu, Tokyo (JP); Masaru Kitsuregawa, Tokyo (JP)

(21) Appl. No.: 15/832,800

(22) Filed: Dec. 6, 2017

(30) Foreign Application Priority Data
Mar. 29, 2017 (JP) 2017-064267

(51) Int. Cl. G06F 17/30

(52) U.S. Cl. CPC G06F 17/30466; G06F 17/30477

(57) ABSTRACT

A database management system generates an execution plan by performing the following (A) and (B): (A) processing of dividing a provisional execution plan that is an access path into one or more query processing blocks that are each a simultaneously executable processing range, the access path being specified on the basis of a received query and indicating an execution order of database operation; and (B) processing of determining, for each of the one or more query processing blocks, whether an execution cost decreases by changing an inner configuration of the query processing block on the basis of at least one of a processing time, performance, and the number of storage devices for one or more processing in the query processing block, and changing the inner configuration of the query processing block when a determination result is true.

### CROSS-REFERENCE TO PRIOR APPLICATION

This application relates to and claims the benefit of priority from Japanese Patent Application number 2017-064267, filed on Mar. 29, 2017 the entire disclosure of which is incorporated herein by reference.

### BACKGROUND

The present invention generally relates to database management and particularly relates to reduction of power consumption amount of query processing.

As technology of reducing power consumption amount of query processing, the technology disclosed in JP4908260 is known. In JP4908260, a database management system analyzes a received query and generates one or more execution plan drafts. Then, the database management system specifies a volume to be accessed on the basis of the generated execution plan drafts. The database management system calculates, for power consumption information of the specified volume, the execution cost of each of one or more execution plan drafts. The database management system selects an execution plan from the one or more execution plan drafts on the basis of the calculated execution cost.

### SUMMARY

In JP4908260, the execution plan is selected on the basis of the execution costs of one or more execution plan drafts. Therefore, when the execution cost of the execution plan draft itself as a choice is appropriate, the execution cost of the execution plan to be selected can be expected to be more appropriate, that is, the power consumption amount of the query processing can be expected to be reduced more.

Thus, a database management system generates an execution plan by performing the following (A) and (B):

(A) processing of dividing a provisional execution plan that is an access path into one or more query processing blocks that are each a simultaneously executable processing range, the access path being specified on the basis of a received query and indicating an execution order of database operation; and

(B) processing of determining, for each of the one or more query processing blocks, whether an execution cost decreases by changing an inner configuration of the query processing block on the basis of at least one of a processing time, performance, and the number of storage devices in one or more processing in the query processing block, and changing the inner configuration of the query processing block when a determination result is true.

The power consumption amount of the query processing can be reduced more.

### BRIEF DESCRIPTION OF THE DRAWINGS

FIG. 1 illustrates a configuration example of a database server according to a first embodiment;

FIG. 2 illustrates an example of a query;

FIG. 3 illustrates a table join relationship corresponding to the query exemplified in FIG. 2;

FIG. 4 illustrates an example of an execution plan draft corresponding to the query exemplified in FIG. 2;

FIG. 5 illustrates an example of the entire flow of processing performed by a database management system and a flow of query optimization in the processing;

FIG. 6 illustrates details of an example of a flow of range determination;

FIG. 7 illustrates details of an example of a flow of temporary table control;

FIG. 8 illustrates a concrete example of temporary table division write;

FIG. 9 illustrates details of an example of a flow of order decision;

FIG. 10 illustrates an example of a configuration of a processing time management table;

FIG. 11 illustrates an example of a configuration of a system performance management table;

FIG. 12 illustrates an example of a configuration of a size management table;

FIG. 13 illustrates an example of a processing performance management table;

FIG. 14 illustrates details of an example of a flow of access path selection according to a second embodiment;

FIG. 15 illustrates an example of an initial execution tree;

FIG. 16 illustrates an example of a first table join candidate to be added to the execution tree in FIG. 15;

FIG. 17 illustrates an example of a second table join candidate to be added to the execution tree in FIG. 15;

FIG. 18 illustrates an example of a third table join candidate to be added to the execution tree in FIG. 15;

FIG. 19 illustrates an example of a fourth table join candidate to be added to the execution tree in FIG. 15;

FIG. 20 illustrates a configuration example of a database server according to a third embodiment; and

FIG. 21 illustrates an example of a configuration of a power consumption management table.

### DESCRIPTION OF EMBODIMENTS

In the description bellow, a database is referred to as “DB” and a database management system is referred to as “DBMS”. The DB server is a server configured to execute the DBMS, for example. A query for the DBMS may be issued from a computer program (for example, an application program) external to the DBMS. The external computer program may be a program executed in the DB server or may be a program executed in an apparatus (for example, a client computer) coupled to the DB server.

In the description bellow, when same types of elements are described without distinction, reference symbols (or the common number in the reference symbols) may be used. When same types of elements are described with distinction, IDs (or reference symbols of the elements) allocated to the elements may be sometimes used.

In the description bellow, an “interface unit” is one or more interfaces. The one or more interfaces may be same types of one or more interface devices (for example, one or more network interface cards (NICs)) or may be two or more different types of interface devices (for example, an NIC and a host bus adapter (HBA)).

In the description bellow, a “memory unit” is one or more memories. At least one memory may be a volatile memory or may be a non-volatile memory.

In the description bellow, a “processor unit” is one or more processors. At least one processor is typically a central processing unit (CPU). The processor may include a hardware circuitry configured to perform a part or all of the processing.

In the description bellow, a “PDEV” means a physical storage device, and typically may be a non-volatile storage device (for example, an auxiliary storage device) such as a hard disk drive (HDD) or a solid state drive (SSD).

In the description bellow, a function is sometimes described with use of an expression “kkk unit”, but the function may be achieved by executing one or more computer programs by a processor unit or may be achieved by one or more hardware circuitries (for example, an FPGA or an application specific integrated circuit (ASIC)). When the function is achieved by executing a program by a processor unit, predetermined processing is performed with use of the memory unit and/or the interface unit as appropriate, and hence the function may be at least a part of the processor unit. Processing described with the function as the subject may be processing performed by a processor unit or an apparatus including the processor unit. The program may be installed from a program source. The program source may be, for example, a storage medium (for example, a non-temporary storage medium) readable by a program distribution computer or a computer. The descriptions of the functions are examples and a plurality of functions may be grouped together into one function or one function may be divided into a plurality of functions.

In the description bellow, management information is sometimes described with use of expressions such as “xxx management table”, but the management information may be expressed by any data structure. That is, the “xxx management information” can be referred to as the “xxx management table” in order to indicate that the management information is independent of the data structure. In the description below, the configurations of the management tables are examples. All information items (for example, a row or a column) may not be necessary for at least one management table, and there may be further information items and at least one information item may be omitted. One management table may be divided into two or more management tables, or all or a part of two or more management tables may be one management table.

In the description bellow, a “computer system” may be at least one of a server system and a storage system. The “server system” may be one or more physical servers (for example, a cluster of servers) or may include at least one virtual server (for example, a virtual machine (VM)). The “storage system” may be one or more physical storage apparatuses or may include at least one virtual storage apparatus (for example, a software defined storage (SDS)).

In the description below, “query processing” means the entire processing that runs by executing a query. The query is executed on the basis of a query execution plan (hereinafter referred to as “execution plan”) that is information indicating execution order of DB operations, and one or more processing runs by the execution of the DB operation. Thus, each of one or more processing that runs by the execution of the DB operation is hereinafter referred to as “DB processing”.

In the description below, the “execution cost” of the query processing means the size of the power consumption amount of the query processing. The power consumption amount increases as the execution cost increases and the power consumption amount decreases as the execution cost decreases. In the embodiments below, the execution cost of the query processing is calculated from the following two viewpoints.
(1) The power consumption amount of the query processing is small when the query processing time is short. This is because the operation time of devices relating to the query processing can be short.
(2) The power consumption of the PDEV (in particular, the power consumption at the time of the activation of the PDEV) has relatively significant effect on the power consumption amount of the query processing.

Thus, in the embodiments below, the execution cost is determined on the basis of the processing time and the number of PDEVs to be activated. Specifically, for example, the execution cost is the product of the processing time and the number of PDEVs to be activated. The execution cost decreases as the number of PDEVs to be activated decreases when there are no differences in the power consumption among the PDEVs and when the processing time is the same. Meanwhile, the execution cost decreases as the processing time is reduced when the number of PDEVs to be activated is the same.

Several embodiments are described below with reference to the drawings. The present invention is not limited by the description below.

### First Embodiment

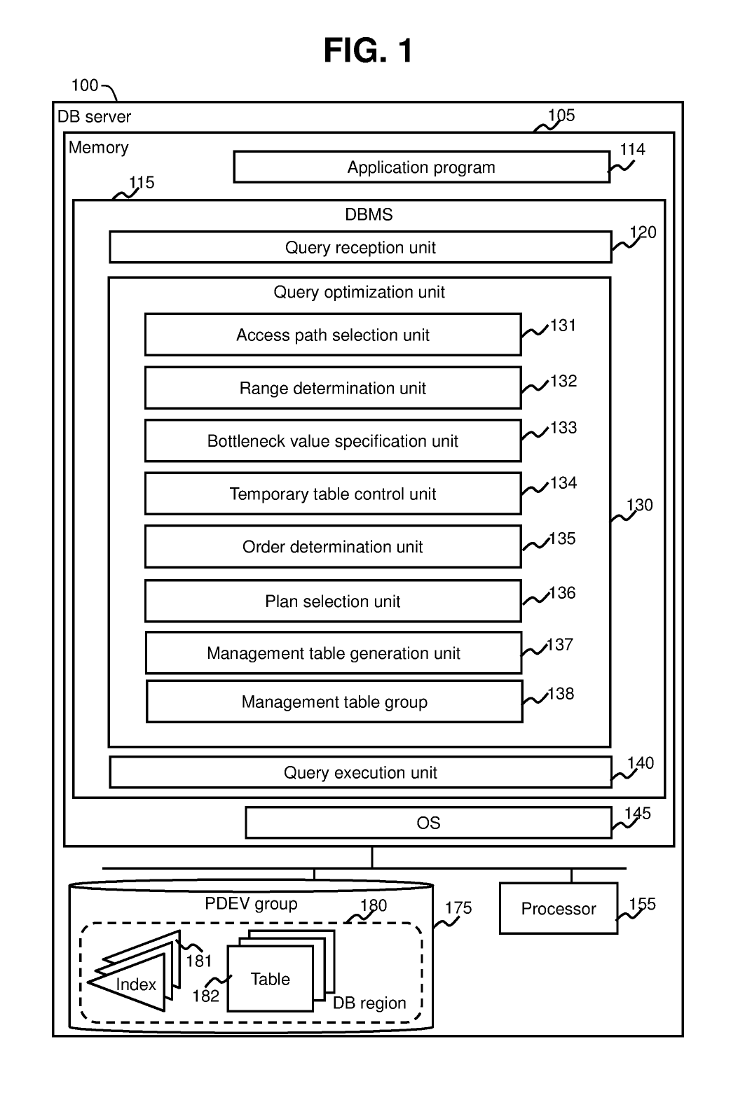

FIG. 1 illustrates a configuration of a DB server according to a first embodiment.

A DB server 100 is an example of a computer system. For example, the DB server 100 may be a personal computer, a workstation, or a mainframe, or may be a virtual computer configured by a virtual program in those computers. The DB server 100 includes a PDEV group 175, a memory 105, and a processor 155 coupled thereto. The DB server 100 may include an input device (not shown) such as a keyboard or a pointing device and an output device (not shown) such as a liquid crystal display. The input device and the output device may be coupled to the processor 155. The input device and the output device may be integrated.

The PDEV group 175 is formed of a plurality of PDEVs. A storage region (hereinafter referred to as “DB region”) 180 based on a storage space of the PDEV group 175 is provided to a DBMS 115. The DB managed by the DBMS 115 is stored in the DB region 180. The DB includes one or more tables (typically, a plurality of tables) 182 and further includes one or more indices (typically, a plurality of indices) 181. The table 182 is a set of one or more records and the record includes one or more columns. The index 181 is a data structure generated by targeting one or more columns and the like of the table 182 and is configured to speed up access to the table 182 by a selection condition including columns and the like targeted by the index 181. The DB region 180 is a set of one or more logical regions. Each logical region is a storage region (for example, an LDEV that is a logical storage device) based on one or more PDEVs. In this embodiment, the states of the PDEVs are broadly classified into an activation state and a power saving state. The “activation state” includes a state in which the PDEV is being activated and a state in which the activation of the PDEV has finished and I/O is possible. The “power saving state” is a state in which the power consumption of the PDEV is so low that I/O is not possible (for example, power off, sleep state, or standby state). Each PDEV transitions from the power saving state to the activation state upon receiving an activation request or an I/O request. Each PDEV transitions from the activation state to the power saving state upon receiving a power saving transition request (or when not receiving a request for a certain amount of time).

The DB server 100 may include a network interface (an example of the interface unit) coupled to the processor 155, and the PDEV group 175 may be included in an external storage apparatus coupled to the network interface.

The memory 105 is an example of a memory unit. The memory 105 is, for example, a volatile dynamic random-access memory (DRAM) and is configured to temporarily store a program to be executed by the processor 155 and data to be used by the program. As the program, for example, there are the DBMS 115, an operating system (OS) 145, and an application program 114. In the DB server 100, the application program 114 issues a query. The DBMS 115 receives the query from the application program 114 and executes the query. When the query is executed, the DBMS 115 issues an input/output (I/O) request to the OS 145 in order to read data from the DB or in order to write data into the DB. The OS 145 receives the I/O request, executes the I/O of the data for the PDEV group 175 in accordance with the I/O request, and returns the execution result to the DBMS 115.

The DBMS 115 includes a query reception unit 120, a query optimization unit 130, and a query execution unit 140. The configuration of the DBMS 115 is merely an example. For example, a constituent element may be divided into a plurality of constituent elements and a plurality of constituent elements may be integrated into one constituent element.

The query reception unit 120 receives the query issued by the application program 114. The query is a query for the DB and is described by a structured query language (SQL), for example.

The query optimization unit 130 generates, from the query received by the query reception unit 120, an execution plan that includes one or more DB operations necessary for the execution of the query. The execution plan is information including one or more DB operations and the relationship of the execution order of the DB operations, for example. The execution plan is sometimes shown by a tree structure having DB operations as nodes and the relationship of the execution order of the DB operations as edges.

The query execution unit 140 executes the query received by the query reception unit 120 in accordance with the execution plan generated by the query optimization unit 130, and returns the execution result to the application program 114. In the query execution, the query execution unit 140 may (a) generate a task for executing the DB operation, (b) issue a read request of data necessary for the DB operation corresponding to the generated task by executing the task, (c) newly generate one or more tasks to respectively execute other DB operations when it is necessary to execute those other DB operations on the basis of the execution result of the DB operation corresponding to the task executed in (b), and (d) perform (b) and (c) for those one or more newly generated tasks. The query execution unit 140 may execute those one or more tasks generated in this way in parallel. When there are two or more executable tasks, the query execution unit 140 may execute at least two tasks out of those two or more tasks in parallel. In the description above, the query execution unit 140 may execute a plurality of DB operations with one task. The query execution unit 140 may not generate a new task each time and may execute the next DB operation in the same task. As the implementation of the task, a user thread achieved by a library and the like may be used in addition to a process, a kernel thread, and the like achieved by the OS 145, for example.

The query optimization unit 130 includes an access path selection unit 131 configured to perform an access path selection, a range decision unit 132 configured to perform a range decision, a bottleneck value specification unit 133 configured to perform a system bottleneck value specification, a temporary table control unit 134 configured to perform a temporary table control, an order decision unit 135 configured to an order decision, a plan selection unit 136 configured to perform an execution plan selection, and a management table generation unit 137 configured to perform a management table generation. The query optimization unit 130 is configured to manage a management table group 138 (a plurality of management tables). The management table group 138 includes a management table prepared in advance and a management table generated by the management table generation unit 137. The components (functions) 131 to 137 of the query optimization unit 130 and the management table group 138 are described in detail later.

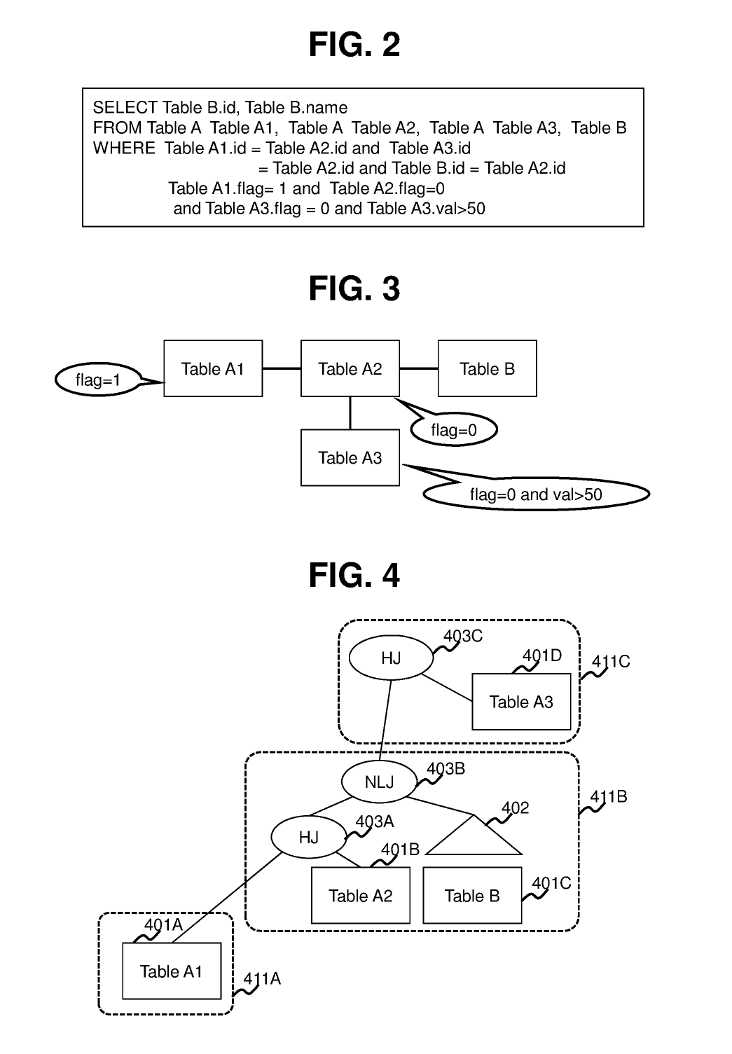

In this embodiment, for example, the query reception unit 120 receives a query exemplified in FIG. 2. A table join relationship in accordance with the query is a table join relationship illustrated in FIG. 3. A plurality of combinations of access paths can be constructed from the table join relationship. In FIG. 3, a “table A1”, a “table A2”, and a “table A3” mean that a table A is read three times. In FIG. 3, the balloons respectively associated with the table A1 to the table A3 indicate narrowing conditions (narrowing conditions described in the query in FIG. 2) designated for the table.

An execution plan draft illustrated in FIG. 4 is an execution plan draft in accordance with one access path taken as an example from the plurality of combinations of access paths constructible from the table join relationship illustrated in FIG. 3. An execution plan draft to be used as the execution plan is selected from one or more execution plan drafts.

As exemplified in FIG. 4, the execution plan draft includes one or more DB operations. As the DB operation, for example, there are table read 401 (401A to 401D), index read 402, and table join 403 (403A to 403C).

The table join is a join between tables. The joining method that improves the execution cost differs depending on the tables to be joined and the nature of the processing query. In FIG. 4, “HJ” means hash join and “NLJ” means nested loop join. In the nested loop join, the DB processing is not necessary before the join, and hence a join result generated each time one record is input is passed to the DB operation in the later stage. Meanwhile, in the hash join, two-stage DB processing is performed. Specifically, after the DB processing in the first stage is completed, the DB processing in the second stage is performed. That is, the DB processing in the first stage and the DB processing in the second stage are separated from each other. Therefore, there are PDEVs that are not accessed simultaneously among the PDEVs that are the target of the DB processing in the hash join. The reference symbol 411 indicates a simultaneously executable processing range. The simultaneously executable processing range is hereinafter referred to as “query processing block”. For example, a query processing block 411C indicates that only the table read 401D is the simultaneously executable processing range in the DB processing in the second stage of the hash join 403C. A query processing block 411B indicates that the index read 402 and the table read 401B and 401C are the simultaneously executable processing range in the DB processing in the second stage of the hash join 403A.

An example of a flow of processing performed in this embodiment is described below. In the description, a management table to be referred to is described as appropriate.

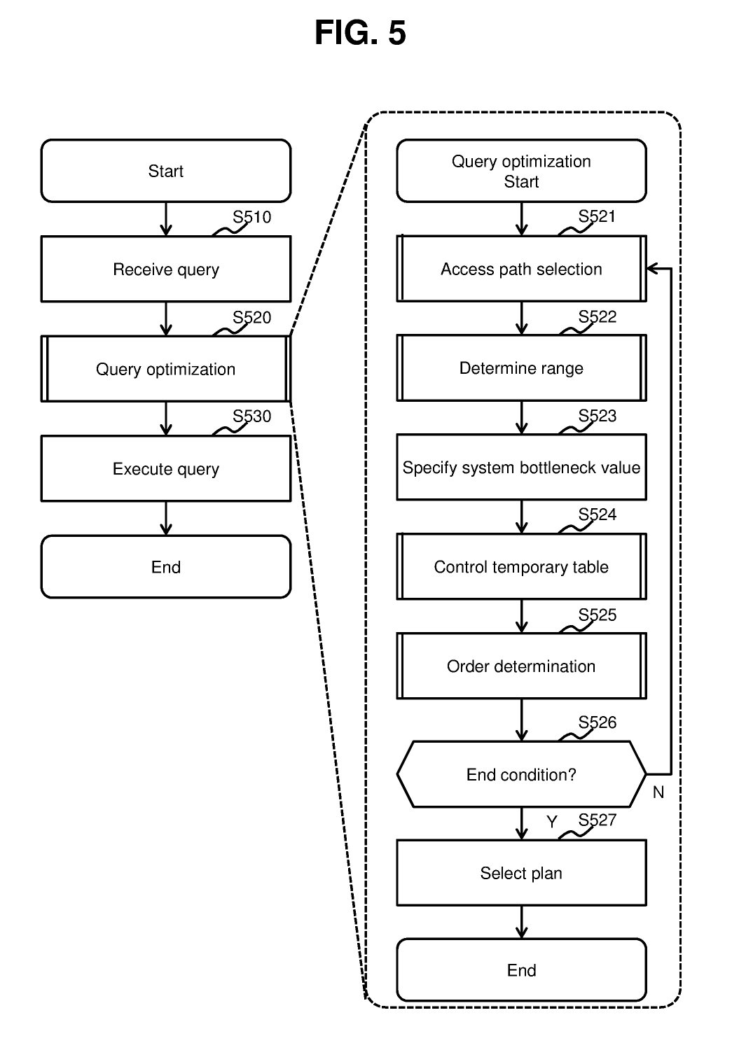

FIG. 5 illustrates an example of the entire flow of processing performed by the DBMS 115 and a flow of query optimization in the processing.

The query reception unit 120 receives a query (S510), the query optimization unit 130 optimizes the received query (S520), and the query execution unit 140 executes the query in accordance with an execution plan acquired by the query optimization (S530).

In the query optimization (S520), the query optimization unit 130 changes the configuration of at least one access path specified on the basis of the query so that the execution cost decreases in units of query processing blocks, to thereby generate an execution plan draft in which the execution cost is further reduced for the access path. The query optimization unit 130 selects an execution plan (to be exact, an execution plan draft to be used as the execution plan) from the one or more generated execution plan drafts. In the query optimization, the following processing is performed.

The access path selection unit 131 performs an access path selection (S521). Specifically, the access path selection unit 131 searches an access path on the basis of the query, and selects the found access path. The access path selected here is a provisional plan draft (provisional execution plan draft). The provisional plan draft (to be exact, information indicating the provisional plan draft) is stored in the memory 105 by the access path selection unit 131. The “access path” is a path showing one or more DB operations and the relationship of the execution order of the DB operations.

The range decision unit 132 performs a range decision (S522). Specifically, the range decision unit 132 divides (partitions) the provisional plan draft into one or more query processing blocks and checks whether there is processing to be processed as a batch for each of one or more query processing blocks.

The bottleneck value specification unit 133 performs a system bottleneck value specification, that is, specifies a system bottleneck value (S523). The system bottleneck value is specified for each query processing block. For each query processing block, the “system bottleneck value” is the lowest I/O performance among one or more I/O performances corresponding to one or more processing in the query processing block. The “I/O performance” is the I/O amount per unit of time, specifically, at least one of the throughput (the I/O data size per unit of time) and the I/O frequency (the number of I/O per unit of time).

The temporary table control unit 134 performs a temporary table control (S524). Specifically, the temporary table control unit 134 determines whether to generate a temporary table and selects the region write the temporary table. The “temporary table” is a table as a part of the read table 181 (specifically, a part of the table 181 that satisfies a designated narrowing condition). In the query processing, the same table 181 may become the read target for a plurality of times. However, when the part needed in the later stage is written in the PDEV group (or the memory 105) as the temporary table at the time of the read in the previous stage, the execution cost of the entire query processing can be expected to be reduced even if the time required for the write is added (even if the execution cost is added).

The order decision unit 135 performs an order decision (S525). Specifically, for each query processing block, the order decision unit 135 decides a processing execution order and a PDEV activation order that activate PDEVs that can exhibit the system bottleneck value when the system bottleneck value specified in S523 is lower than the system PDEV maximum I/O performance (the maximum I/O performance exhibitable when all the PDEVs including the data of the query processing block to be processed are activated). In S522 to S525, the provisional plan draft is updated as appropriate. When S525 is finished, the provisional plan draft is established as the execution plan draft.

The access path selection unit 131 determines whether an end condition of S521 to S526 is satisfied (S526). The end condition may be at least one of the following, for example.
S521 to S526 are performed for all combinations of access paths.
N (N is a natural number) execution plan drafts of which execution cost is equal to or lower than a predetermined threshold value are generated.

When the determination result of S526 is false (S526: N), S521 is executed.

When the determination result of S526 is true (S526: Y), the plan selection unit 136 selects an execution plan from one or more execution plan drafts (S527). The determination in S526 may be omitted. In that case, S522 to S525 may be performed for one found access path, and the execution plan generated as the result may be the execution plan to be used in the query execution.

S522 to S525 out of the query optimization are described below in detail.

S522: Range Decision

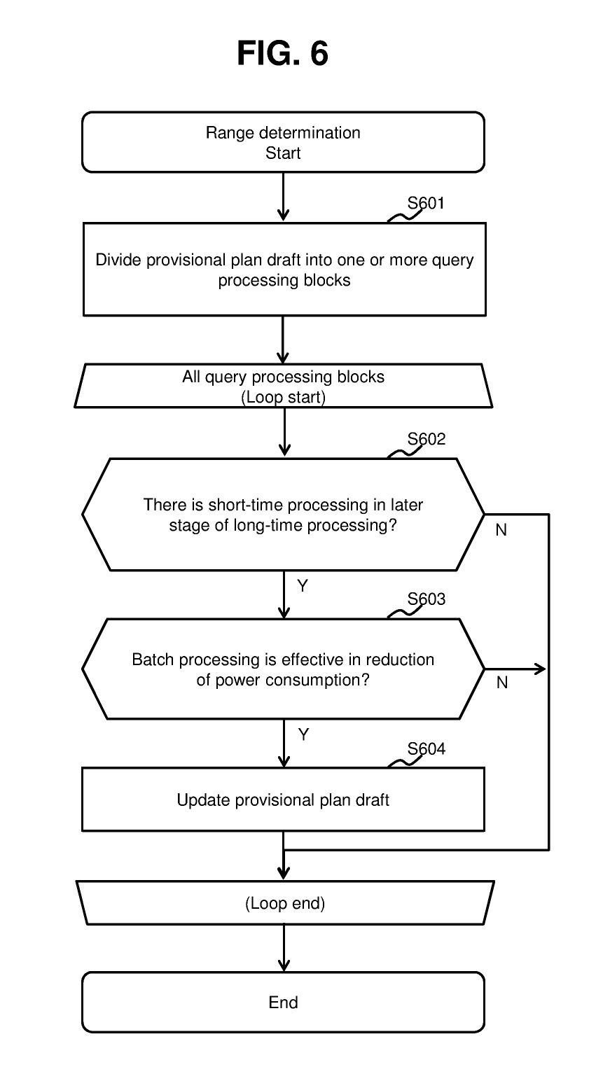

FIG. 6 illustrates details of an example of a flow of the range decision.

In S601, the range decision unit 132 divides the provisional plan draft into one or more query processing blocks. A DB management table (not shown) is referred to here, for example. The DB management table is one of the management tables included in the management table group 138. The DB management table holds various information on the DB, for example, at least one of the following:
information indicating the size, the location, and the like for each DB element (for example, the table or the index);
information indicating the statistics of the DB (for example, information indicating the number of entries of the index, information indicating the number of records of the table, the maximum value, the average value, and the minimum value for the values of each column, and the value distribution for each column);
information indicating the I/O performance of each PDEV storing the DB; and
information indicating the power consumption of each PDEV storing the DB.

The information on the location of the DB element includes an ID of a logical region in which the DB element is stored and an ID of the PDEV that is the basis of the logical region. The DB element to be accessed and the storage region based on the PDEV that needs to be activated for the access can be grasped from the DB management table. For example, when there are two or more DB elements in two or more different PDEVs, respectively, those two or more the DB elements can be simultaneously read. The range decision unit 132 divides the provisional plan draft into one or more query processing blocks (simultaneously executable processing ranges) on the basis of the DB management table. As a result, the provisional plan draft includes information indicating each of one or more query processing blocks.

The range decision unit 132 performs the following S602 to S604 for each of all the query processing blocks. One query processing block is described as an example below. The query processing block is referred to as “target block” in the description of S602 to S604.

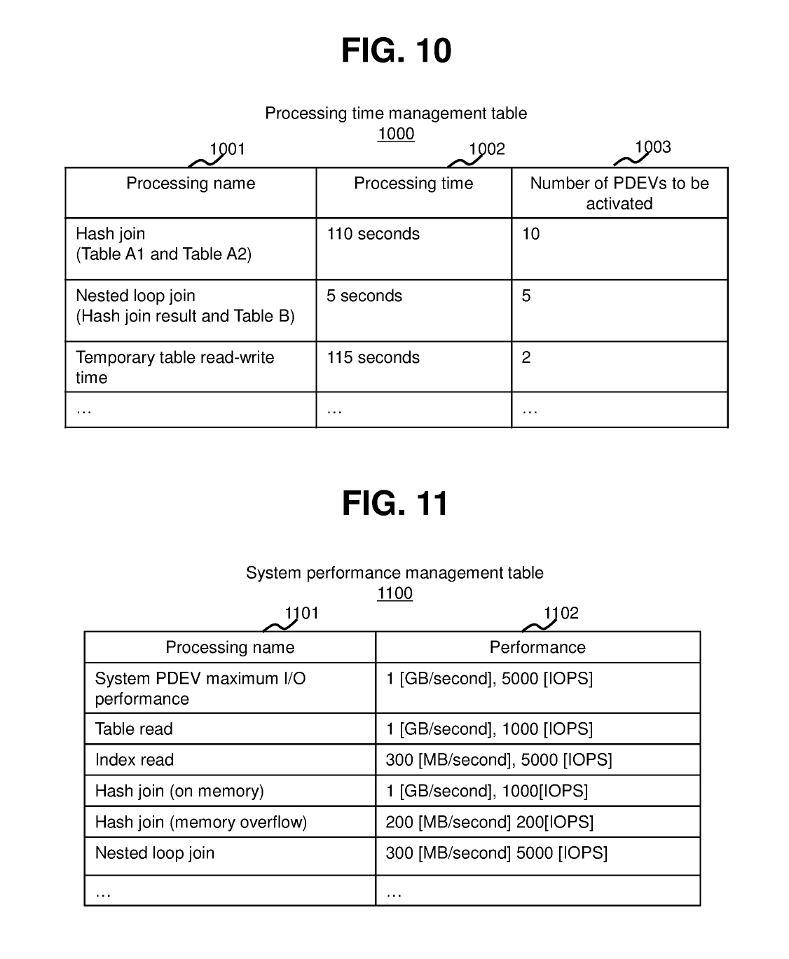

In S602, the range decision unit 132 determines whether there is short-time DB processing in the later stage of long-time DB processing in the target block. In the determination, a processing time management table 1000 exemplified in FIG. 10 is referred to.

The processing time management table 1000 is a management table generated by the management table generation unit 137. The processing time management table 1000 includes an entry for each DB processing, and each entry holds information such as a processing name 1001, a processing time 1002, and the number of PDEVs to be activated 1003. The processing name 1001 indicates the name of the DB processing. The processing time 1002 is a value estimated as the time needed for the DB processing on the basis of the I/O amount (for example, the size of the data (for example, the DB element) to be read or written), the performance (for example, the ideal performance) of the processor 155, and the like. The number of PDEVs to be activated 1003 indicates the number of PDEVs necessary for the DB processing (the PDEVs needed to be activated for the DB processing). At least one of the processing time 1002 and the number of PDEVs to be activated 1003 is a value specified on the basis of the DB management table described above, for example.

The processing time 1002 for each DB processing in the target block is grasped with reference to the processing time management table 1000. Therefore, the range decision unit 132 can determine whether there is short-time processing in the later stage of long-time processing in the target block. The determination result is true here when the processing time 1002 of the DB processing in the previous stage is longer than the processing time 1002 of the DB processing in the later stage and when a difference between the processing time 1002 of the DB processing in the previous stage and the processing time 1002 of the DB processing in the later stage is equal to or higher than a predetermined threshold value.

When the determination result of S602 is true, the range decision unit 132 determines in S603 whether batch processing is effective in reducing the power consumption amount. Specifically, the range decision unit 132 does not execute the result generated from the long-time DB processing in the previous stage successively in the short-time DB processing in the later stage. Instead, the range decision unit 132 writes the result generated from the long-time DB processing in the previous stage into the PDEV group 175 (or the memory 105) and then determines whether the execution cost is reduced by processing the result as a batch in the short-time DB processing in the later stage. Also in this determination, the processing time management table 1000 is referred to. Specifically, the determination result is true when (execution cost X)>(execution cost Y), for example,

where

(execution cost X)={(the processing time 1002 of the long-time DB processing)+(the number of PDEVs to be activated 1002 in the short-time DB processing)}×{(the number of PDEVs to be activated 1003 in the long-time DB processing)+(the number of PDEVs to be activated 1003 in the short-time DB processing)},

and

(execution cost Y)=(the execution cost of the long-time DB processing)+(the execution cost of the read-write of the long-time DB processing result)+(the execution cost of the short-time DB processing).

When the determination result of S603 is true, the range decision unit 132 updates the provisional plan draft in S604. The provisional plan draft after the update is a provisional plan draft indicating the following. That is, the provisional plan draft indicates that, for the target block, the generation result of the long-time DB processing in the previous stage is written into the PDEV group 175 (or the memory 105) and then the generation result (written data) is read in the short-time DB processing in the later stage, to thereby perform the batch processing. The target block is divided into a query processing block of the long-time DB processing and a query processing block of the short-time DB processing. The range determination processing may be recursively performed for the query processing block after the division.

S523: System Bottleneck Value Specification

The bottleneck value specification unit 133 specifies a system bottleneck value for each query processing block. One query processing block is described as an example below. The query processing block is referred to as “target block” in the description of S523.

The bottleneck value specification unit 133 refers to a system performance management table 1100 exemplified in FIG. 11. The system performance management table 1100 includes an entry for each DB processing, and each entry holds information such as a processing name 1101 and performance 1102. The processing name 1101 indicates the name of the DB processing. The performance 1102 indicates exhibitable maximum I/O performance. In FIG. 11, the “system maximum I/O performance” is the maximum I/O performance exhibitable by the DBMS 115 in the query processing. The system performance management table 1100 may be a management table generated by the management table generation unit 137 on the basis of the use rate of the processor 155, the abovementioned DB management table, and the like, or may be a management table prepared in advance.

The bottleneck value specification unit 133 specifies one or more performances 1102 respectively corresponding to one or more DB processing in the target block, and specifies the lowest performance 1102 out of those one or more performances 1102 as the system bottleneck value.

S524: Temporary Table Control

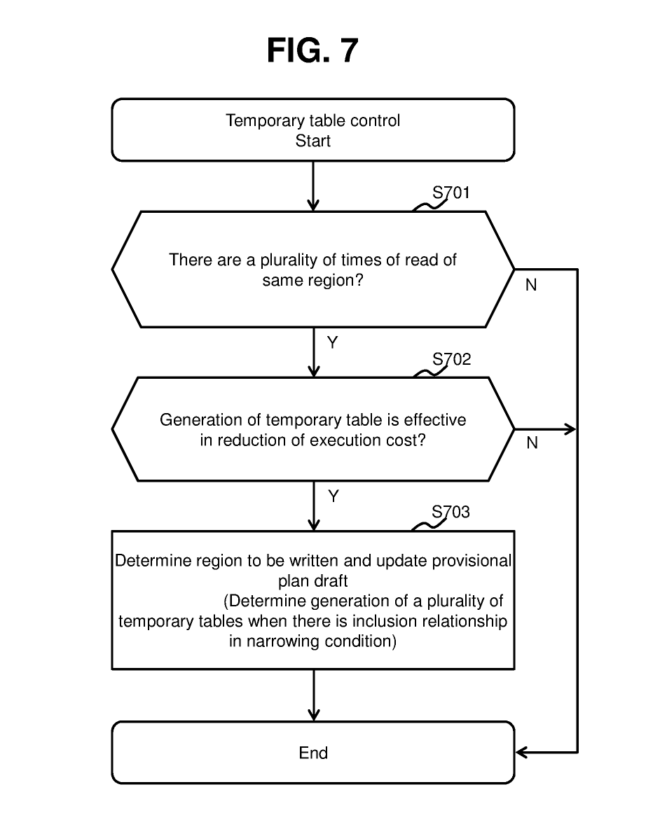

FIG. 7 illustrates details of an example of a flow of the temporary table control.

In S701, the temporary table control unit 134 refers to the provisional plan draft, and determines whether the same table is read a plurality of times. When there is at least one of such tables, the determination result of S701 is true, and hence S702 is performed. When there are two or more tables (the same tables) to be read a plurality of times, S702 is performed for each of those two or more tables. When one same table is read two or more times, S702 is performed each time.

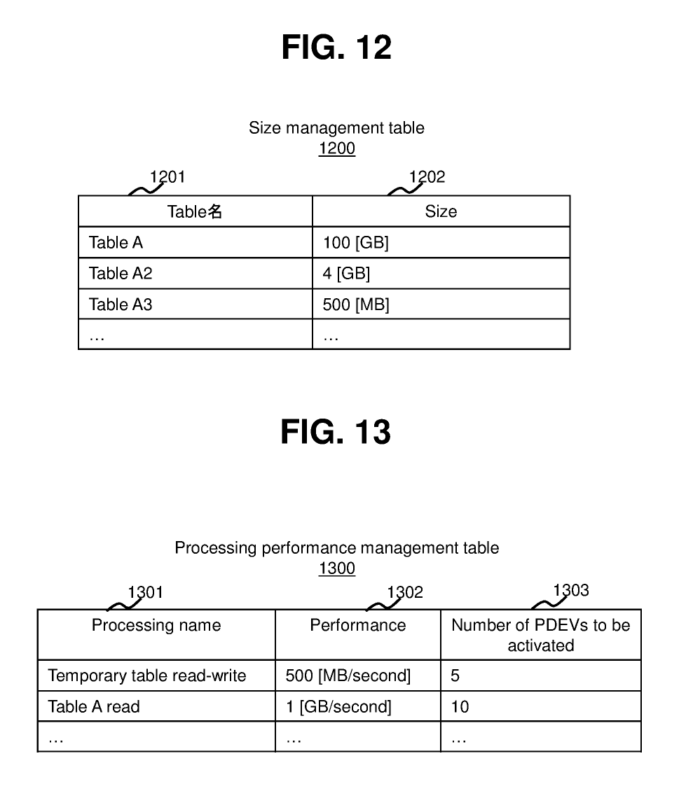

In S702, the temporary table control unit 134 determines whether the execution cost is reduced by writing the temporary table (the table part satisfying the narrowing condition at N-th (N is an integer of 2 or more) read) of the same table into the PDEV group 175 (or the memory 105). In this determination, a size management table 1200 exemplified in FIG. 12 and a processing performance management table 1300 exemplified in FIG. 13 are referred to.

The size management table 1200 includes an entry for each table, and each entry holds information such as a table name 1201 and a size 1202. The table name 1201 indicates the name of the table (the same table or the temporary table). The size 1202 indicates the size of the table. The size 1202 is a value specified from the abovementioned DB management table, for example.

The processing performance management table 1300 includes an entry for each DB processing and each entry holds information such as a processing name 1301, performance 1302, and the number of PDEVs to be activated 1303. The processing name 1301 indicates the name of the DB processing. The performance 1302 indicates the performance exhibited in the DB processing. The number of PDEVs to be activated 1303 indicates the number of the PDEVs necessary for the DB processing (the PDEVs needed to be activated for the processing). At least one of the performance 1302 and the number of PDEVs to be activated 1303 is a value specified from the abovementioned DB management table, for example.

For example, the determination result of S702 is true when (execution cost P) >(execution cost Q),

where

(execution cost P)

=the execution cost of reading the same table K times (K=an integer of 2 or more)

=(the processing time of reading the same table K times)×(the number of PDEVs to be activated 1303 corresponding to the table read of the same table)

=[{(the size 1202 of the same table)×K/(the performance 1302 of the table read)}×(the number of PDEVs to be activated 1303 corresponding to the table read of the same table)], and

(execution cost Q)

=the execution cost of reading and writing the temporary table+(the execution cost of reading once the table to be read K times)

−(the processing time of reading and writing the temporary table)×(the number of PDEVs to be activated 1303 corresponding to the read-write of the temporary table)+(the processing time of reading once the table to be read K times)×(the number of PDEVs to be activated 1303 corresponding to one table read of the table to be read K times)

=[{(the size 1202 of the temporary table)/(the performance 1302 of the read-write of the temporary table)}×(the number of PDEVs to be activated 1303 corresponding to the read-write of the temporary table)+{(the size 1202 of the table to be read K times)/(the performance 1302 of the read of the table to be read K times)}×(the number of PDEVs to be activated 1303 corresponding to one table read of the table to be read K times)].

When the determination result of S702 is true, in S703, the temporary table control unit 134 decides a region in which the temporary table is to be written and updates the provisional plan draft.

The region in which the temporary table is to be written is, for example, a region satisfying any one of the following conditions.

(Condition 1) A region that is the same as a region storing a table to be read in a query processing block including the read of the temporary table. This is because the number of PDEVs to be activated can be saved.
(Condition 2) A region that is the same as a region storing a table to be read in a query processing block in the previous stage of the query processing block including the read of the temporary table. This is because the power consumption amount can be expected to be reduced by leaving the PDEV in the activation state for the read of the temporary table than by causing the PDEV in the activation state to transition to the power saving state when the read of the table ends.
(Condition 3) A region that is the same as a region storing a table to be read in a query processing block in the later stage of the query processing block including the read of the temporary table. This is because the power consumption amount can be expected to be reduced by leaving the PDEV that is in the activation state for the read of the temporary table in the activation state than by causing the PDEV in the power saving state to transition to the activation state when the read of the table starts.
(Condition 4) A region that provides the lowest total query execution cost during write of the temporary table out of regions in which the temporary table can be written.

The provisional plan draft after the update includes the information on the region in which the temporary table of the same table (for example, the table A) is to be written and information indicating that the generated temporary table is to be read.

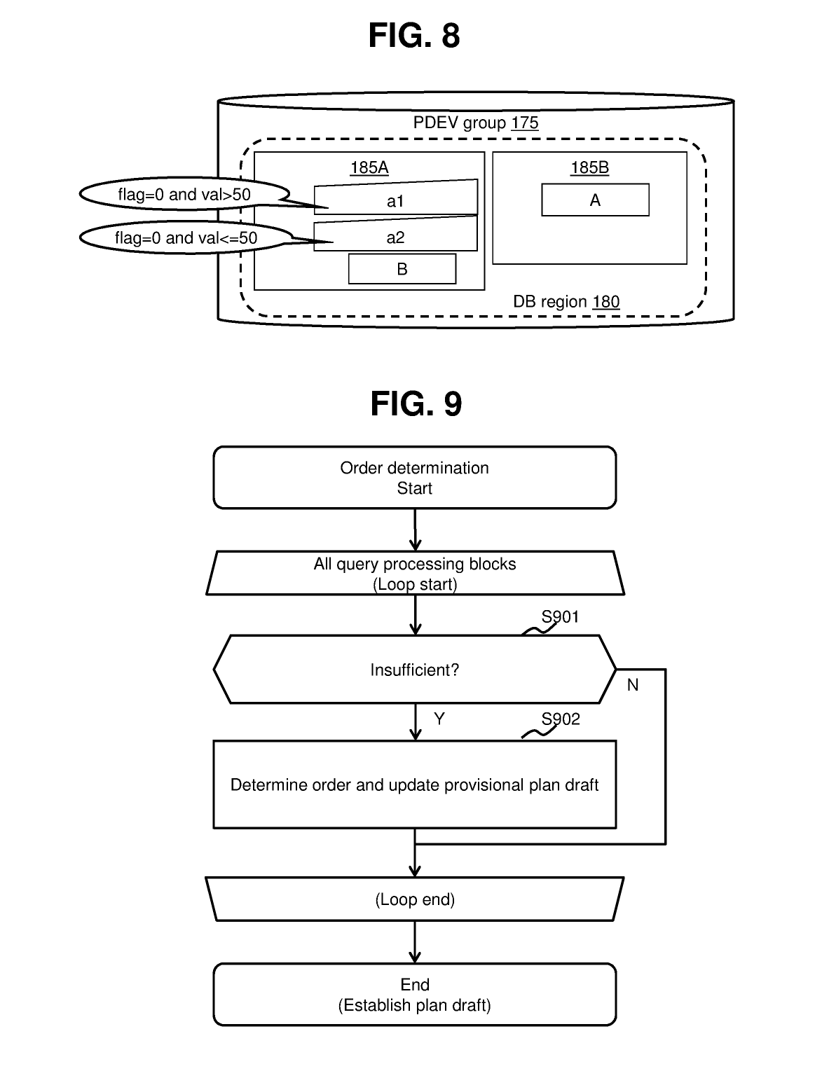

In S703, the temporary table control unit 134 may determine whether there is an inclusion relationship in a plurality of narrowing conditions respectively corresponding to the plurality of times of the read of to the same table. When the determination result is true, the temporary table control unit 134 updates the provisional plan draft to a draft of writing the temporary table corresponding to the narrowing condition as a superset by dividing the temporary table into a plurality of temporary tables. One of the plurality of temporary tables is a temporary table corresponding to the narrowing condition as a subset. With use of the table A1 to the table A3 illustrated in FIG. 4 as an example, a concrete example of temporary table division write is described with reference to FIG. 8.

The DB region 180 of the PDEV group 175 includes a plurality of sub DB regions 185 including sub DB regions 185A and 185B. Each sub DB region 185 is a set of one or more logical regions (for example, one or more LDEVs). The table A is stored in the sub DB region 185B and a table B is stored in the sub DB region 185A.

In the example of FIG. 4, the table A is read three times. This is a plurality of times of read of the same table A. A narrowing condition in the second read of the table A (hereinafter referred to as “first narrowing condition”) is flag=0 and a narrowing condition of the third read of the table A (hereinafter referred to as “second narrowing condition”) is flag=0 and val>50. The first and second narrowing conditions are in an inclusion relationship. Specifically, the second narrowing condition is included in the first narrowing condition. Therefore, the second narrowing condition is the subset and the first narrowing condition is the superset.

Therefore, the temporary table control unit 134 updates the provisional plan draft to a provisional plan draft indicating the following contents.
When the table A is read for the first time, the table A part corresponding to the first narrowing condition is extracted.
The part satisfying the second narrowing condition (flag=0 and val>50) out of the table A part is written as a temporary table al (a table read in the third read of the table A).
The part not satisfying the second narrowing condition (the part satisfying flag=0 and val<=50) out of the table A part is written as a temporary table a2.
The temporary tables a1 and a2 are to be written into the sub DB region 185A in which the table B is stored.

The reason that the temporary tables a1 and a2 are to be written into the sub DB region 185A in which the table B is stored is because the second read of the table A satisfies the abovementioned (Condition 1). The third read of the table A also satisfies the abovementioned (Condition 2).

Even when there are inclusion relationships in a plurality of narrowing conditions respectively corresponding to a plurality of times of read of the same table, the temporary table control unit 134 may determine whether writing the temporary table by dividing the temporary table into a plurality of temporary tables reduces the execution cost of the query processing (for example, whether the number of the narrowing conditions as subsets is lower than a predetermined threshold value). When the determination result is true, the temporary table control unit 134 may divide the temporary table into a plurality of temporary tables. As a result, the temporary table can be prevented from being written a large number of times when there is a large number of subsets.

S525: Order decision

FIG. 9 illustrates details of an example of a flow of the order decision.

The order decision unit 135 performs the following S901 and S902 for all the query processing blocks. One query processing block is described as an example below. The query processing block is referred to as “target block” in the description of S901 and S902.

In S901, the order decision unit 135 determines whether the system bottleneck value is lower than the system PDEV maximum I/O performance for the target block. When the determination result of S901 is false, one or more processing is supposed to be simultaneously executed for the target block, and all the PDEVs necessary for the one or more processing are supposed to be put in an activation state.

When the determination result of S901 is true, in S903, the order decision unit 135 decides a DB processing execution order and a PDEV activation order that activate PDEVs that can exhibit the system bottleneck value. For example, for the query processing block 411B exemplified in FIG. 4, when a system bottleneck value specified on the basis of the management table 1100 exemplified in FIG. 11 is the performance 1102 corresponding to the hash join (memory overflow), the order decision unit 135 decides a processing execution order and a PDEV activation order that activate PDEVs that can exhibit the performance 1102 corresponding to the hash join (memory overflow). Then, the order decision unit 135 updates the provisional plan draft in accordance with the decision. Specifically, at the time of the table read 401B of the table A2, it is understood from the processing performance management table 1300 exemplified in FIG. 13 that 10 PDEVs are stored in the table A and the processing performance is 1 [GB/second]. Next, it is understood from the system performance management table 1100 exemplified in FIG. 11 that the hash join (memory overflow) performance is 200 [MB/s] and 200 [IOPS] and it can be calculated from the number of PDEVs of the table A and the performance that the performance of the system bottleneck value, that is, 200 [MB/s] is satisfied when two PDEVs are activated. Thus, by activating every two PDEVs storing the table A, and performing the table read 401B in order from the data included in the activated PDEV, the power consumption amount can be reduced without degrading the processing performance.

When the order decision (S525) ends, the provisional plan draft is established as an execution plan draft.

The plan selection unit 136 selects an execution plan draft having the lowest execution cost, for example, from one or more generated execution plan drafts as an execution plan.

The query execution unit 140 executes a query on the basis of the selected execution plan. The query execution unit 140 may specify one or more query processing blocks from the execution plan and control the transition of the PDEVs to the activation state or the power saving state in units of query processing blocks. For example, the query execution unit 140 may issue an activation request for the execution of the first query processing block so that PDEVs corresponding to the first query processing block are activated. The query execution unit 140 may perform the following when ending the first query processing block and then executing the second query processing block:
issuing a power saving request so that the PDEV that is in the activation state in the first query processing block but is not needed to be in the activation state in the second query processing block transitions to the power saving state; and
issuing an activation request (or an I/O request) so that the PDEV that is in the power saving state in the first query processing block and is needed to be in the activation state in the second query processing block transitions to the activation state.

As described above, the query execution unit 140 may control the PDEV to transition to the activation state or the power saving state on the basis of the execution plan and in accordance with the progress of the query processing as appropriate (in units of query processing blocks). As the method of switching the PDEV between the activation state and the power saving state, a method in accordance with the configuration of a computer system configured to execute the DBMS may be employed. For example, one of the following may be employed.
The DBMS 115 issues an activation request (or an I/O request) designating a PDEV and the OS 145 issues the activation request (or the I/O request) to the PDEV. The PDEV that has received the activation request (or the I/O request) transitions from the power saving state to the activation state. In the same manner, the DBMS 115 issues a power saving request designating a PDEV and the OS 145 issues the power saving request to the PDEV. The PDEV that has received the power saving request transitions from the activation state to the power saving state.
The DBMS 115 issues an activation request (or an I/O request) designating a logical region (for example, an LDEV ID or a logical address). The OS 145 or a storage controller (not shown) specifies a PDEV that is the basis of the logical region and issues the activation request (or the I/O request) to the specified PDEV. The PDEV that has received the activation request (or the I/O request) transitions from the power saving state to the activation state. In the same manner, the DBMS 115 issues a power saving request designating a logical region. The OS 145 or the storage controller (not shown) specifies a PDEV that is the basis of the logical region and issues the power saving request to the specified PDEV. The PDEV that has received the power saving request transitions from the activation state to the power saving state. The storage controller may be a physical controller including a processor or may be a virtual controller (for example, a virtual machine (VM)).

The query optimization according to this embodiment has been described above.

The power consumption amount of the PDEV activation is high in percentage in the power consumption amount of the query processing. According to this embodiment, in the generation of the execution plan draft, the query processing block is defined as a simultaneously executable processing range and the plan draft is updated in units of query processing blocks on the basis of the processing time or the number of PDEVs to be activated. As a result, the execution plan draft having as low an execution cost as possible can be generated for each access path.

In the query processing, all the data that is the target of the query processing is not always accessed in the entire period of the query processing. In this embodiment, the activation state and the power saving state of the PDEV is controlled in units of query processing blocks each that is simultaneously executable processing range (distinction is made between the batch processing and the non-batch processing (simultaneously executed two or more processing) even for the same query processing block). As a result, the total activation state time in the query processing can be suppressed, that is, the power consumption amount of the query processing can be reduced. The “total activation state time” is the total amount of the activation state time of the plurality of PDEVs. For each PDEV, the “activation state time” is the time during which the PDEV is in the activation state.

In the query processing, a system component other than the PDEV is conceived to be the bottleneck, for example, a CPU bottleneck (for example, sorting of large scale data) or a network bandwidth bottleneck. When a system component other than PDEV is the bottleneck, the query processing can be continued without adversely affecting the system performance by activating PDEVs that satisfy the bottleneck. The abovementioned system bottleneck value (the performance 1102 exemplified in FIG. 11) is a value that also considers a case in which a system component other than the PDEV is the bottleneck. Therefore, the total activation state time can be expected to be further suppressed, that is, further power saving can be expected.

In the description above, dividing the access path into one or more query processing blocks has the following significance. That is, the query processing block as a simultaneously executable processing range is defined, and hence it can be checked in a small range, that is, the query processing block and not in a wide range, that is, the entire plan whether a configuration is appropriate, specifically, whether the execution cost is reduced the most by simultaneously executing all the DB processing in the query processing block. Thus, on the basis of at least one of the processing time, the performance, and the number of PDEVs to be activated of the DB processing in the query processing block, it is determined for each query processing block whether changing the inner configuration of the query processing block reduces the execution cost. When the determination result is true, the inner configuration of the query processing block is changed. Specifically, short-time DB processing in the later stage of long-time DB processing is changed to batch processing performed after long-time DB processing, a table to be read in the query processing block in the later stage is changed to a part of a table (temporary table) to be read in the query processing block in the previous stage, and the DB processing execution order and the PDEV activation order are determined on the basis of the system bottleneck value. As a result, the plan having a lower execution cost can be obtained in units of query processing blocks. “The inner configuration of the query processing block” is the execution order of the DB processing, the addition of the temporary table read-write processing, and the activation order of the PDEVs for the DB processing.

### Second Embodiment

A second embodiment is described. Now, parts that are different from that of the first embodiment are mainly described and description of parts that are in common with that of the first embodiment are omitted or simplified.

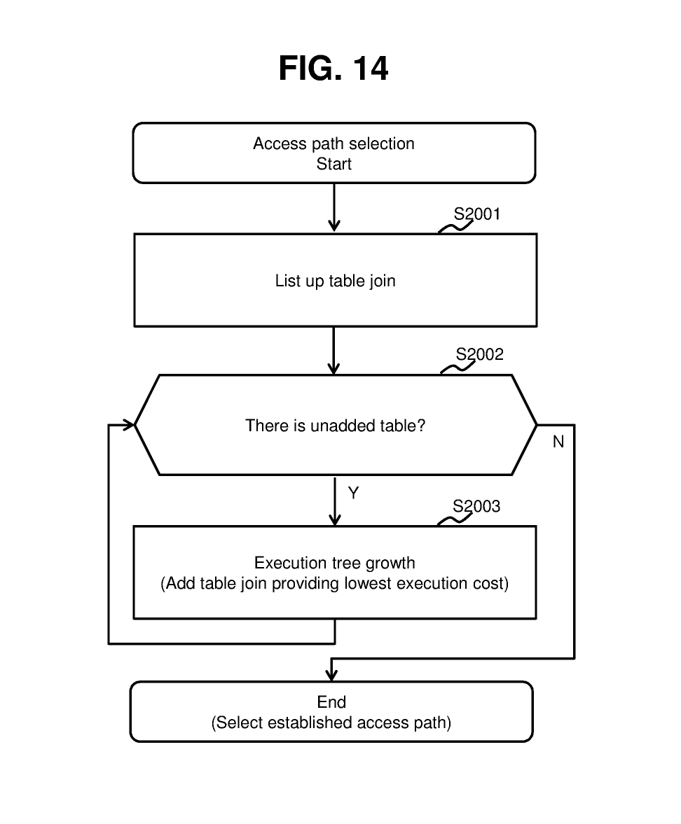

In the second embodiment, in S521, the access path selection unit 131 generates (searches) an access path and selects the generated access path in a flow illustrated in FIG. 14.

FIG. 14 illustrates details of an example of a flow of access path selection according to the second embodiment. In the description bellow, a tree up to the access path establishment (a tree being generated) is referred to as “execution tree”.

In S2001, the access path selection unit 131 lists up the table join on the basis of the received query. When the same table is read a plurality of times, the same table belongs to each of the plurality of table joins as a join target.

In S2002, the access path selection unit 131 determines whether there is a table unadded to the execution tree.

When the determination result of S2002 is true, the access path selection unit 131 adds in S2003, to the execution tree, a table join that provides, after being added, the lowest execution cost of the entire execution tree among the table joins to which the unadded table belongs. After S2003, the processing returns to S2002. The execution cost of each table join can be specified on the basis of the processing time management table 1000 exemplified in FIG. 10.

When the determination result of S2002 is false, the access path is established and the access path selection unit 131 selects the access path.

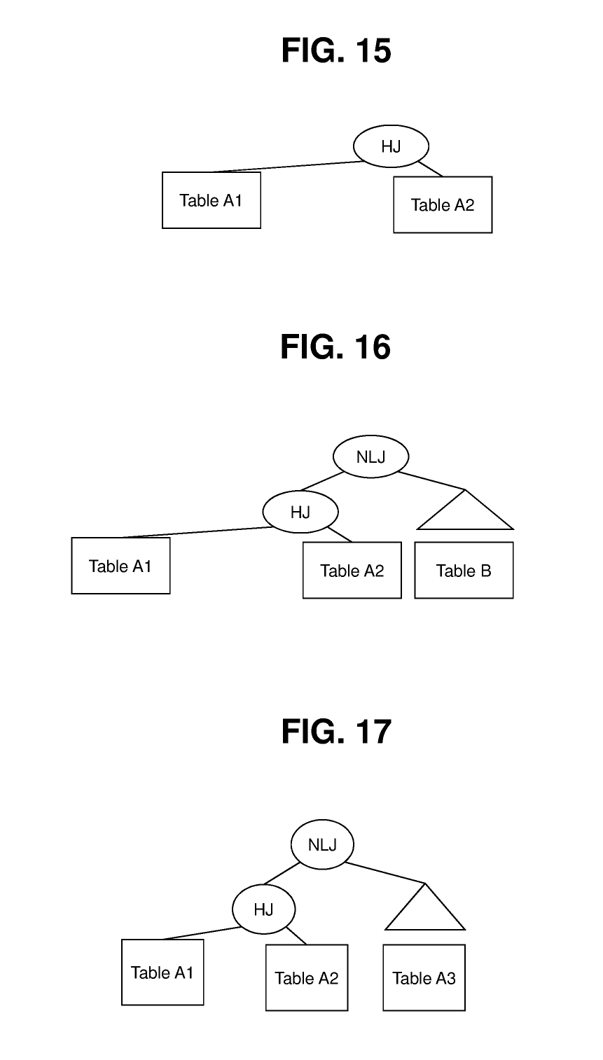

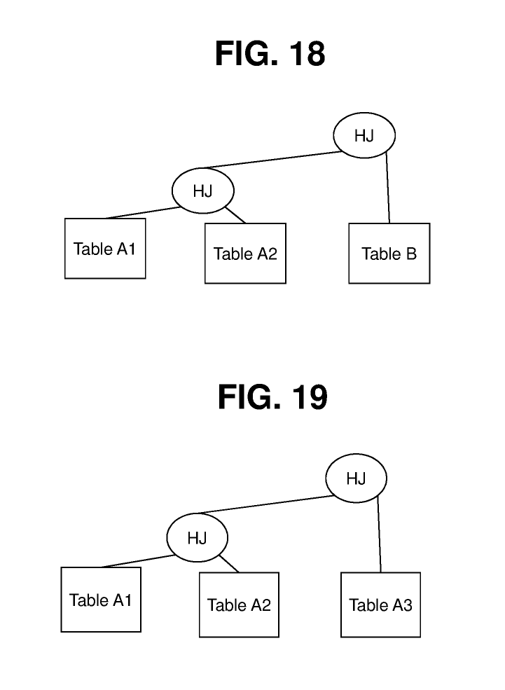

In FIG. 14, the execution tree grows as the following, for example. First, the access path selection unit 131 generates an execution tree (FIG. 15) showing a join between joinable tables. Next, the access path selection unit 131 selects a table join (FIG. 16) having the lowest execution cost among a plurality of table joins (FIG. 16 to FIG. 19). In this way, the access path exemplified in FIG. 4 is generated.

According to this embodiment, each time a table join is added for the growth of the execution tree, the table join that provides, after being added, the lowest execution cost of the entire execution tree is selected to be added. As the execution cost, the execution cost after optimization using the query processing block may be used. The access path (provisional plan draft) grown and generated as above is later changed in configuration in units of query processing blocks, and the execution plan draft is established. Therefore, the possibility that the execution cost of the execution plan draft is appropriate can be expected to further increase. When a subquery or a derived table is included, for example, a plurality of execution trees may grow in parallel or an execution tree of a main query may be grown after an execution tree of the derived table or the subquery is grown first. The processing to be added to the execution tree may not only be the table join but may also be the derived table. In that case, an execution tree indicating the derived table is added to an execution tree indicating the entire query. Execution cost calculation of the execution tree may be performed including the location of sort processing and the like.

### Third Embodiment

A third embodiment is described. Now, parts that are different from that of the first embodiment are mainly described and description of parts that are in common with that of the first embodiment are omitted or simplified (the third embodiment may be applied to the second embodiment).

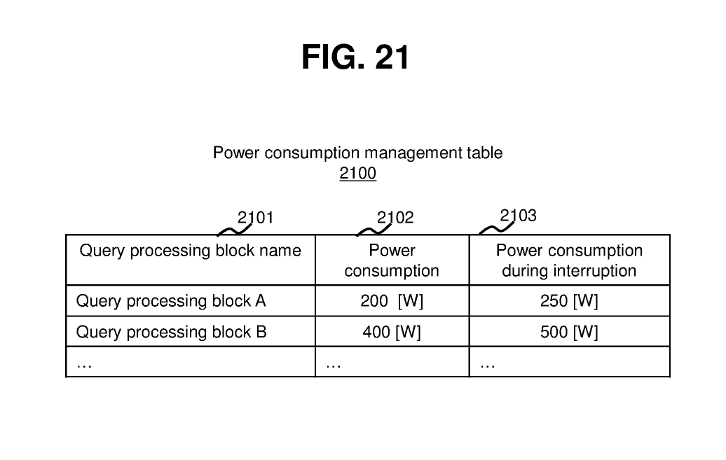

In the third embodiment, the DBMS 115 includes an event reception unit 125 configured to receive an event from an external device. For each query processing block, the management table generation unit 137 calculates the power consumption of the query processing block and the power consumption of the query processing block when the processing is interrupted, and generates a power consumption management table 2100 (see FIG. 21) showing the calculation result. When the event reception unit 125 receives a query processing interruption event while a plurality of query processing is already in an execution state in the DBMS 115, the query execution unit 140 selects a query to be interrupted on the basis of the power consumption management table 2100. An example of the query processing interruption event is the exceedance of a system power consumption threshold value by the external device.

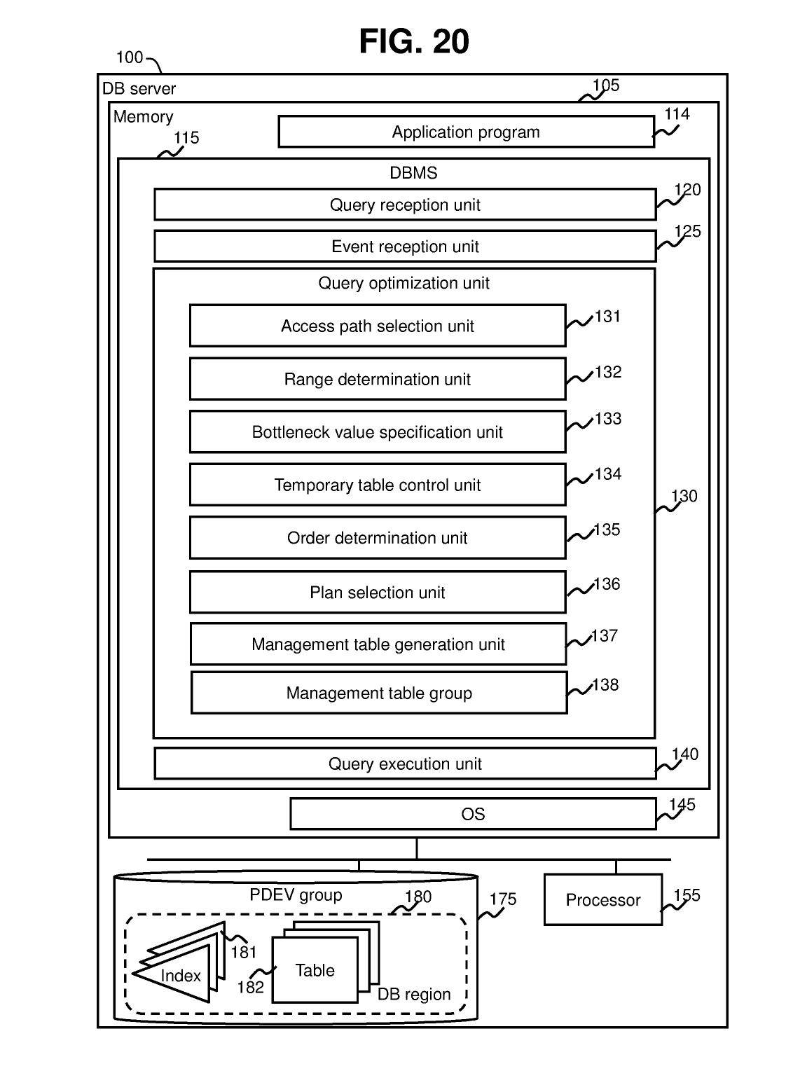

FIG. 20 is a configuration example of a DB server according to the third embodiment.

As described above, the DBMS 115 further includes the event reception unit 125.

In the third embodiment, in S527, the management table generation unit 137 calculates, for the query processing block of the execution plan, the power consumption necessary for the processing of the query processing block and the power consumption necessary for interrupting the processing of the query processing block, and stores the power consumption management table 2100 that is an example of information indicating the calculation result into the management table group 138. The interruption of the processing of the query processing block is achieved by writing the processing result generated from the query processing block to the temporary table and interrupting a query after query processing block processing to be interrupted is ended. During the interruption processing, the power consumption temporarily becomes higher than before the interruption processing because the storage device, to which the temporary table having the processing result written therein is stored, is activated.

When the event reception unit 125 receives events such as the exceedance of the power consumption threshold value from the external device while the plurality of queries are already in the execution state, a query to be interrupted is selected on the basis of the power consumption management table 2100 and query processing block information in the processing held by the query execution unit 140. A conceivable example of this selection of the query to be interrupted is repeating of the processing of interrupting a query from the query having the largest power consumption in the query processing block on the basis of the power consumption management table 2100, until the power consumption exceedance event is not received. When the received power consumption exceedance event is imparted with numerical value information of the exceedance power consumption, a necessary reduction value of the power consumption may be calculated from the information, and the minimum number of queries satisfying the calculated value may be selected as the query to be interrupted with use of the information of the management table group 138. The query execution unit 140 interrupts the selected query (query to be interrupted).

When the query reception unit 120 receives a new query, the query execution unit 140 may interrupt a query being executed or start the execution of the new query on the basis of power consumption information from a power consumption meter, the power consumption for each query processing block of the new query, and priority degree information on the query being executed and the new query.

FIG. 21 is an example of the power consumption management table 2100.

The power consumption management table 2100 includes an entry for each query processing block, and each entry holds information such as a query processing block name 2101, a power consumption 2102, and a power consumption during interruption 2103. The query processing block name 2101 indicates the name of the query processing block. The power consumption 2102 indicates the power consumption of the processing of the query processing block. The power consumption during interruption 2103 indicates the power consumption when the query processing is interrupted in the query processing block.

According to this embodiment, when the power consumption of the system exceeds a certain value at a state in which a plurality of queries are already being executed, the DBMS 115 can interrupt the queries so that the power consumption of the system becomes equal to or lower than the certain value. As a result, only the queries that enable the power consumption of the system to be equal to or lower than the certain value by being interrupted are interrupted and re-executed later, and hence the maximum power consumption of the system can be suppressed to a value equal to or lower than the certain value while suppressing the increase in the processing time.

Several embodiments have been described above, but those embodiments are examples for describing the present invention and are not intended to limit the scope of the present invention to only those embodiments. The present invention can also be embodied in other various forms. For example, when column storage is employed for the storage of the DB, the size, the location, and the like may be managed in the DB management table in units of columns for each table 181, and the processing time and the number of PDEVs to be activated for each processing may be defined on the basis of such DB management table.

What is claimed is:

1. A database management system configured to manage a database stored in a plurality of storage devices, the database management system comprising:
a query interface configured to receive a query to the database;
a query optimization unit configured to generate an execution plan on the basis of the received query; and
a query execution unit configured to execute the received query on the basis of the generated execution plan, wherein
the query optimization unit is configured to generate the execution plan by performing the following (A) and (B):
(A) processing of dividing a provisional execution plan that is an access path into one or more query processing blocks that are each a simultaneously executable processing range, the access path being specified on the basis of the received query and indicating an execution order of database operation; and
(B) processing of determining, for each of the one or more query processing blocks, whether an execution cost decreases by changing an inner configuration of the query processing block on the basis of at least one of a processing time, performance, and the number of storage devices for one or more processing in the query processing block, and changing the inner configuration of the query processing block when a determination result is true.

2. The database management system according to claim 1, further comprising:
an event interface configured to receive an event from an external device, wherein
the query optimization unit is configured to calculate, for each query processing block, a power consumption and a power consumption during processing interruption, and
the query execution unit is configured to select a query to be interrupted on the basis of power consumption information of the query processing block, when a plurality of query processing is already being executed in the database and the event interface receives a query processing interruption event.

3. The database management system according to claim 1, wherein
(B) involves performing the following (b11) to (b13) for each of the one or more query processing blocks:
(b11) determining whether a processing time of second processing in a later stage of first processing is shorter than a processing time of the first processing;
(b12) determining whether an execution cost decreases by executing the second processing as a batch after the first processing is finished, when a determination result of (b11) is true; and
(b13) deciding executing the second processing after the first processing instead of executing the first processing and the second processing simultaneously, when a determination result of (b12) is true.

4. The database management system according to claim 1, wherein
(B) involves performing the following (b21) to (b23):
(b21) determining whether a same table in the database is to be read a plurality of times;
(b22) determining whether an execution cost of reading and writing a temporary table that is a table part of the same table satisfying a narrowing condition at N-th read is lower than an execution cost of reading the same table when a determination result of (b21) is true, where N is an integer of 2 or more; and
(b23) deciding writing the temporary table corresponding to the N-th read when a determination result of (b22) is true.

5. The database management system according to claim 4, wherein
(b23) involves performing the following (b23-1) and (b23-2) when a determination result of (b22) is true:
(b23-1) determining whether a plurality of narrowing conditions respectively corresponding to the plurality of times of read have an inclusion relationship; and
(b23-2) deciding writing a temporary table corresponding to a narrowing condition as a superset by dividing the temporary table into a first temporary table that is a temporary table corresponding to the narrowing condition as a subset and a second temporary table that is a temporary table corresponding to a condition other than the subset, when a determination result of (b23-1) is true.

6. The database management system according to claim 4, wherein
a region in which each temporary table is to be written is a region satisfying any one of the following conditions:
(Condition 1) a region that is the same as a region storing a table to be read in a query processing block including the read of the temporary table;
(Condition 2) a region that is the same as a region storing a table to be read in a query processing block in a previous stage of the query processing block including the read of the temporary table;
(Condition 3) a region that is the same as a region storing a table to be read in a query processing block in a later stage of the query processing block including the read of the temporary table; and
(Condition 4) a region that provides a lowest total query execution cost during write of the temporary table out of regions in which the temporary table can be written.

7. The database management system according to claim 1, wherein
(B) involves performing the following (b31) and (b32) for each of the one or more query processing blocks:
(b31) determining whether a bottleneck performance that is a lowest performance among performances corresponding to processing to be simultaneously executed in the query processing block is lower than an exhibitable maximum performance; and
(b32) deciding a processing execution order and a storage device activation order that enable the bottleneck performance to be exhibited, when a determination result of (b31) is true.

8. The database management system according to claim 1, wherein
the query execution unit is configured to control transition of the storage devices to an activation state or a power saving state in units of query processing blocks when executing the received query.

9. The database management system according to claim 1, wherein
the query optimization unit is configured to perform the following (X) and (Y):
(X) determining whether there is a table unadded to an execution tree among tables to be joined as a table join specified on the basis of a query; and
(Y) adding, to the execution tree, a table join that provides, after being added, a lowest total execution cost of the entire execution tree among table joins to which the unadded table belongs or an execution tree, and returning to (X), when a determination result of (X) is true, and
an execution tree when the determination result of (X) is false is the access path.

10. A computer system, comprising:
a plurality of storage devices configured to store a database; and
a database management system configured to manage the database, wherein
the database management system is configured to:
receive a query to the database;
optimize a query by generating an execution plan on the basis of the received query; and
execute the received query on the basis of the generated execution plan,
in the optimizing of a query, the execution plan is generated by performing the following (A) and (B):
(A) processing of dividing a provisional execution plan that is an access path into one or more query processing blocks that are each a simultaneously executable processing range, the access path being specified on the basis of the received query and indicating an execution order of database operation; and
(B) processing of determining, for each of the one or more query processing blocks, whether an execution cost decreases by changing an inner configuration of the query processing block on the basis of at least one of a processing time, performance, and the number of storage devices for one or more processing in the query processing block, and changing the inner configuration of the query processing block when a determination result is true.

11. A database management method for managing a database stored in a plurality of storage devices, the database management method comprising:
receiving a query to the database;
optimizing a query by generating an execution plan on the basis of the received query; and
executing the received query on the basis of the generated execution plan, wherein
in the optimizing of a query, the execution plan is generated by performing the following (A) and (B):
(A) processing of dividing a provisional execution plan that is an access path into one or more query processing blocks that are each a simultaneously executable processing range, the access path being specified on the basis of the received query and indicating an execution order of database operation; and
(B) processing of determining, for each of the one or more query processing blocks, whether an execution cost decreases by changing an inner configuration of the query processing block on the basis of at least one of a processing time, performance, and the number of storage devices for one or more processing in the query processing block, and changing the inner configuration of the query processing block when a determination result is true.
